(19) United States
(12) Patent Application Publication
(10) Pub. No.: US 2003/0088455 A1
(43) Pub. Date: May 8, 2003

(54) Increasing pubilc awareness of non-profit organizations' missions

(76) Inventors: Harry E. Gruber, Rancho Santa Fe, CA (US); Stephen Klein, San Diego, CA (US); Ephraim Feig, San Diego, CA (US)

Correspondence Address: Kintera, Inc., Suite 240, 9605 Scranton Road, San Diego, CA, 92121, US

(21) Appl. No.: 10/004,900

(22) Filed: Nov. 2, 2001

(51) Int. Cl. G06F 17/60

(52) U.S. Cl. 705/10

(57) ABSTRACT

A web-based, interactive method and system for simultaneously: (a) advertising and increasing awareness of charitable, nonprofit, philanthropic, political or other fundraising organizations (ORG), (b) advertising corporate or other sponsors (Sponsors), and (c) raising donations for the ORGs is provided. In one embodiment, the method comprises providing the participant an opportunity to take a quiz on a website in exchange for a Sponsor making a donation to an ORG, the quiz having one or more questions, taking the quiz by answering the questions, the participant selecting an answer from two or more provided answers, if the selected answer is correct, then awarding one or more points. The method further comprises asking questions about the ORG's mission and activity. The method further comprises asking questions about the Sponsor's business or activities. The method further comprises receiving the contact information of the participant. The method further comprises providing a score based on the number of correct answers in the quiz. The method further comprises calculating the total number of participants taking the quiz, the total points per participant or team. In another embodiment, the invention provides players an opportunity to play a game or a trivia online in exchange for a sponsor making a donation to the ORGs. By playing the game or the trivia, the players can also enter a sweepstake and have an opportunity to win one or more prizes. The players are awarded a score based on the performance in the game or the trivia. The players can be awarded prizes based on the performance in the game or the trivia.

### BACKGROUND

1. Field of Invention

The present invention relates to a method and system that allows charitable, nonprofit, philanthropic, political and other organizations to increase public awareness about their missions and activities and allows corporations to increase name recognition and profile.

2. Description of Prior Art

Many charitable, non-profit, philanthropic, social, political or other organizations (hereinafter generally referred to as NPOs) rely on fundraising. Common fundraising methods include media events, mail campaigns, telephone calls and other events.

In order to have a successful fundraising event, it is critical that the public is aware of the NPOs' missions and activities. The success of fundraising often depends on the public awareness of the NPOs' missions and activities. Increased public awareness of the NPOs' missions and activities leads to increased name recognition, higher profile, and increased personal commitment, which often results in greater success in fundraising. Conversely, a lack of public awareness makes it difficult for the NPOs to successfully raise money.

The NPOs use various methods to educate the public about their missions and activities in an effort to increase public awareness. If the public is more educated about the NPOs' activities and mission, they are more willing to make a donation to the NPOs.

Some NPOs, for example, use advertisements on television, radio and other popular media to educate the public. Advertisements, however, are expensive and most NPOs often lack financial resources to advertise.

Furthermore, most advertisements in the media are short, and thus do not provide enough information to educate the public. While short advertisements in the media may lead to increased name recognition, it may not adequately educate the public to increase public awareness of the NPOs' activities and missions. In order to adequately educate the public and increase awareness, NPOs must pursue an aggressive and expensive advertising campaign.

While NPOs often lack the financial resources to pursue an aggressive advertising campaign, NPOs generally have goodwill among the public. People often associate NPOs with good causes. Corporations and other businesses, on the other hand, generally have adequate resources to advertise effectively to increase their profile and name recognition. Corporations spend large amounts of money to increase their name recognition and profile among the public. Thus, corporations can benefit by associating themselves with the NPOs by tapping into the goodwill associated with the NPOs. Likewise, NPOs can benefit by associating themselves with the corporations and using the corporate resources to increase public awareness.

Currently there are no efficient schemes that allow NPOs and corporations to cooperate to increase public awareness of the NPOs' missions and activities and increase the corporations' name. Furthermore, there are no efficient and convenient means to measure public awareness of the NPOs' and the corporations' missions.

Accordingly, there is need for a method and system that allows the NPOs and the corporations to work together for their mutual benefit. More specifically, what is needed is a method and system that allows the NPOs to increase public awareness of their missions and activities and also allows the corporations to increase their name recognition and profile. Such a scheme will allow the NPOs to raise more money and allow the corporations to tap into the goodwill associated with the NPOs. Also, there is need for a system and method that allows the NPOs and the corporations to conveniently measure public awareness of their missions and activities.

### SUMMARY OF THE INVENTION

The invention is directed to a web-based, interactive method and system for simultaneously: (a) advertising and increasing awareness of charitable, nonprofit, philanthropic, political or other fundraising organizations (ORG), (b) advertising corporate or other sponsors (Sponsors), and (c) raising donations for the ORGs. In one embodiment, the method comprises providing the participant an opportunity to take a quiz on a website in exchange for a Sponsor making a donation to an ORG in the participant's name, the quiz having one or more questions, taking the quiz by answering the questions, the participant selecting an answer from two or more provided answers. The method further comprises awarding one or more points based on the number of correct answers.

The method further comprises asking questions about the ORG's mission and activity. The method further comprises asking questions about the Sponsor's business or activities. The method further comprises receiving the contact information of the participant. The contact information comprises the email address of the participant.

The method further comprises providing a score based on the number of correct answers in the quiz. The method further comprises calculating the total number of participants taking the quiz, the total points per participant or team. The method further comprises providing the contact information to the Sponsor. The method further comprises providing the contact information to the ORG. In another embodiment, the invention allows the public to play a game or a trivia and learn about the ORGs and the sponsors.

In another embodiment, the invention provides players an opportunity to play a game or a trivia online in exchange for a sponsor making a donation to the ORGs. The players are awarded a score based on the performance in the game or the trivia. The players can be awarded prizes based on the performance in the game or the trivia. By playing the game or the trivia, the players can also enter a sweepstake and have an opportunity to win one or more prizes.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like elements, in which:

FIG. 1 is a block diagram of one embodiment of the present invention in association with a wide area network;

FIG. 2 illustrates a system level diagram of one embodiment of the invention.

FIG. 3 is an exemplary web page that illustrates the invention.

FIGS. 4-11 shows how the awareness quiz is administered in accordance with one embodiment of the invention.

FIGS. 12 and 13 are flow diagrams of the sequence of the method steps in accordance with two embodiments of the invention.

### DETAILED DESCRIPTION OF THE INVENTION

Turning first to the nomenclature of the specification, the detailed description which follows is represented largely in terms of system block diagrams, processes and symbolic representations by conventional computer components, including a processor associated with a general-purpose computer system, memory storage devices for the processor, and connected display devices. These operations include the manipulation of data bits by the processor and the maintenance of these bits within data structures residing in one or more of the memory storage devices. Such structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

It should be understood that the systems and processes described herein are not related or limited to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hardwired logic or programs stored in non-volatile memory, such as read-only memory.

The present invention provides a solution to the above-mentioned problems associated with existing fundraising schemes. In one embodiment, the present invention is directed to a method and system that allow NPOs and corporations to cooperate to increase public awareness of the NPOs' missions and activities and simultaneously increase the corporations' name recognition and profile. The invention allows the NPOs and the corporations to work together for their mutual benefit. The invention allows the NPOs to raise more money and allows the corporations to tap into the goodwill associated with the NPOs.

The present invention can be conveniently implemented on the Internet using one or more web pages. The invention can also be utilized during entertainment or interactive events on various media, such as the Internet.

In one embodiment, the invention utilizes a quiz to educate and increase public awareness of the NPOs and the corporate sponsors. A quiz comprising one or more questions related to a particular subject matter, such as the missions and activities of the NPOs and the corporate sponsors, is an effective means for educating the public. The invention provides the public with an incentive to take the quiz and learn more about the NPOs and the corporate sponsors.

In another embodiment, the invention utilizes various games or trivia to educate and increase public awareness. The public is encouraged to play the games or trivia and at the same time learn about the NPOs and the corporate sponsors. The content and structure of these games, trivia and quizzes are well known and are sometimes seen on television. The games, trivia and quizzes are designed to educate the public about the NPO and the corporate sponsors. In exchange for playing the games, trivia or quizzes, a corporate sponsor can make a donation to a charity in the name of a participant. The participant can also win a prize by playing the games, trivia or quizzes, or by entering a drawing or winning by earning a high score. The invention can also utilize a poll to educate public about the NPOs and the corporate sponsors.

In accordance with one embodiment of the invention, the corporate sponsors agree to make a donation in the name of the participant (the person that takes the quiz). The participant gets the satisfaction of making a donation, while the NPOs and the sponsors get increased awareness. In another embodiment, the participants provide their names and contact information when they take the quiz. This information is used by the NPOs to solicit charitable donations, and is also used by the corporate sponsors to advertise their products and services. In one embodiment, the participants can enter a contest to win prizes by providing their names.

In one embodiment, the participants on the Internet can be asked one more questions to determine their awareness of the NPOs' missions and activities and the corporate sponsors' activities. The questions (and the answers provided) are designed to increase public awareness of the NPOs' activities and to create higher consumer affinity to the organizations and their cause. A higher level of consumer affinity to the organizations' cause results in increased donations of time, money, goods and services. The questions (and the answers provided) also increase the name recognition of the corporate sponsors.

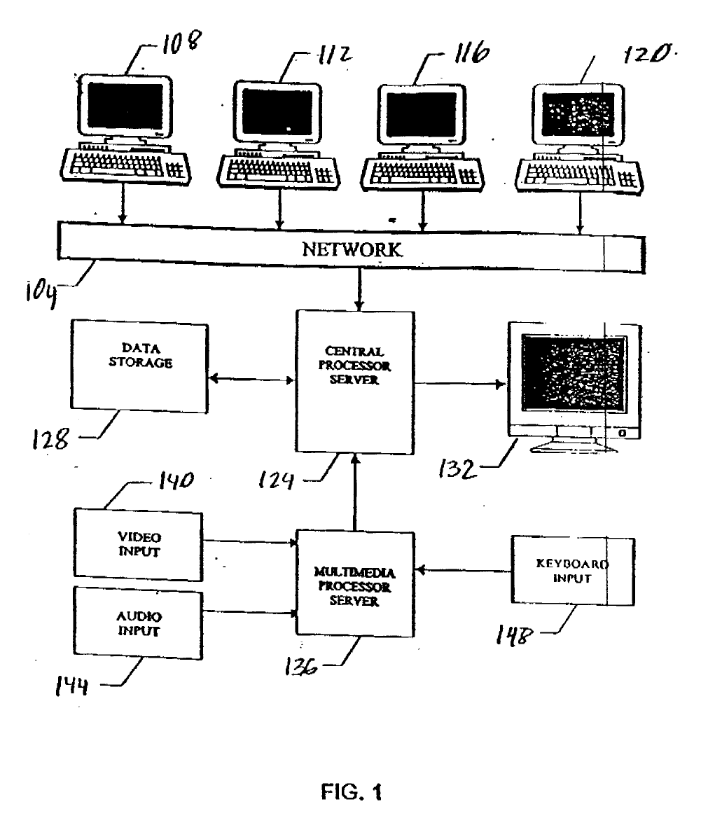

Referring now in more detail to the drawings, FIG. 1 is a block diagram of the present invention in association with a wide-area network. In FIG. 1, a wide-area network (e.g., the Internet) 104 is shown in conjunction with a number of representative user stations 108, 112, 116, and 120. It is well known in the art how to structure such wide-area network connections to provide two-way communication between various stations and locations connected to the network. In FIG. 1, a representative central processor server 124 is shown connected to the network 104 for two-way interactive communication between the central processor server 124 and the plurality of user stations. Also, as is well known in the art, many levels of communication can occur across network 104 as among individual stations and as between central processor servers and individual stations.

The present invention can be implemented over the wide area network 104, such as the Internet, using one or more web pages. The web pages allow a person to take an awareness quiz designed to increase public awareness of the NPOs' missions and increase corporate name recognition.

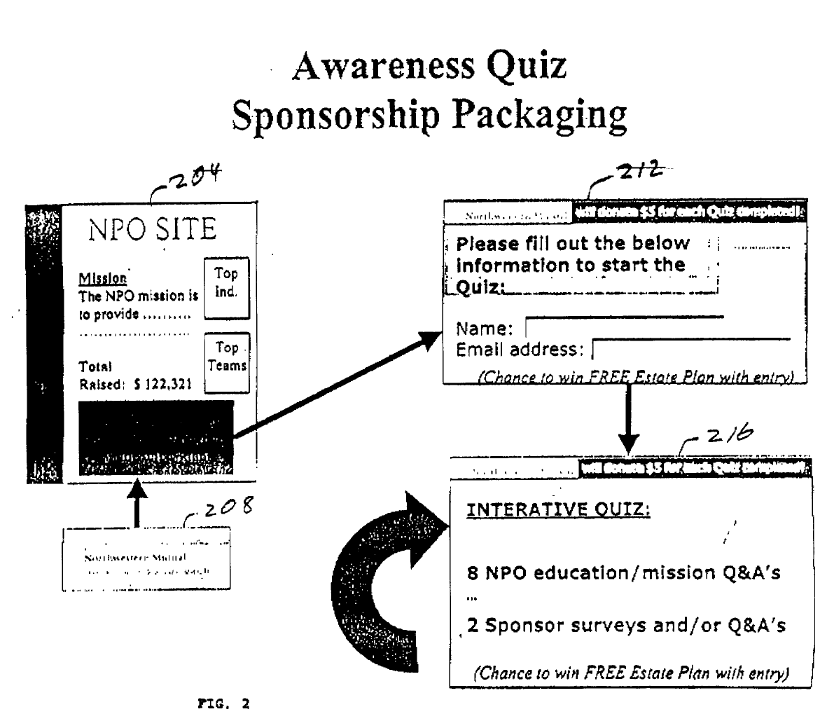

FIG. 2 illustrates one embodiment of the invention. In FIG. 2, an NPO web page 204 provides information about the NPO's missions and activities. The web page 204 is linked to a wide area network, such as the Internet. The web page 204 is usually accessed by a user through a personal computer.

The web page 204 includes information about one or more fundraising campaigns or any other information. The web page 204 includes information about the amount of money raised, top individual fundraisers and top fundraising or game teams.

In one embodiment, the web page 204 allows participants/visitors to take an awareness quiz. The awareness quiz is designed to increase public awareness of the NPOs' missions and activities and simultaneously increase the name recognition and profile of one or more corporate sponsors. Thus, the awareness quiz educates the public about the NPOs and the corporate sponsors. In some instances, the corporation's and the NPO's missions may be complementary. For example, Volvo, an automobile manufacturer promotes safety features in its vehicles, including protection against head and back injury. Thus, in this example, Volvo's mission is complementary to a NPO that engages in medical research to treat or prevent head and back injuries.

According to the invention, in exchange for taking the quiz, one or more corporate sponsors agree to make a donation to the NPO in the name of the participant. For example, in FIG. 2, a corporate sponsor will donate $5 to the NPO in the participant's name.

Referring again to FIG. 2, if a participant decides to take the awareness quiz, the participant enters a web page 212. In one embodiment, the participant moves from one web page to another using links provided in the web pages. The web page 212 requires a participant to fill out certain information, such as name and address. Additional information about the awareness quiz is provided in web page 216. For example, the web page 216 lists the total number of questions in the quiz and their categories. The questions are designed to test and thereby teach about the NPO and its missions and often about the corporate sponsor.

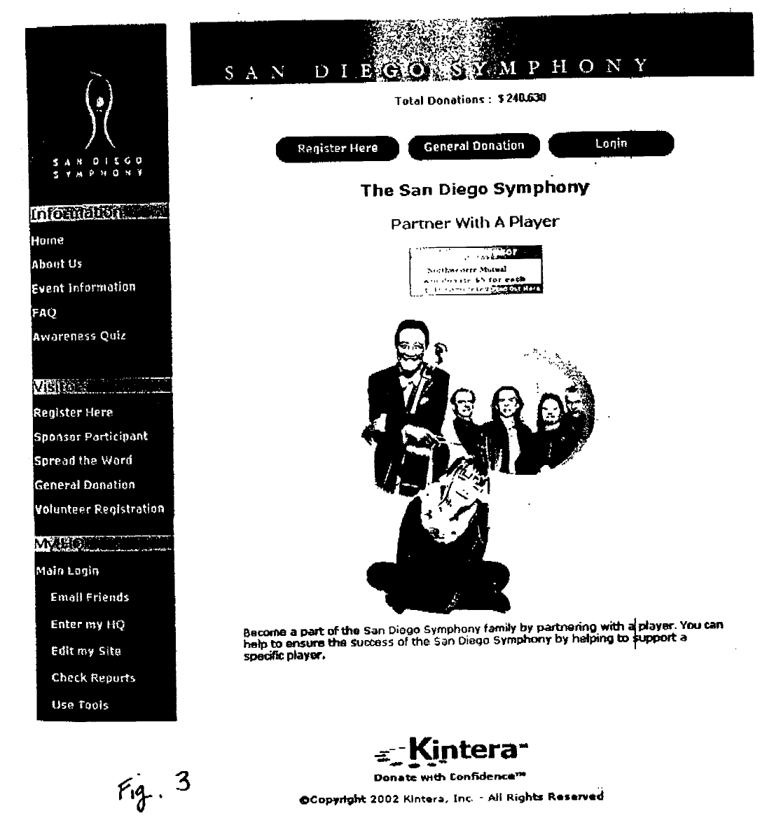

FIG. 3 is an exemplary web page 300 that illustrates the invention. In FIG. 3, an NPO intends to increase its public awareness as well as raise money. The NPO (The San Diego Symphony) in this example has teamed up with a corporate sponsor to get its message out by educating the public about its missions and activities. The corporate sponsor (Northwestern Mutual) in this example agrees to donate $5 to the NPO in the name of a participant if the participant agrees to take an awareness quiz. The corporate sponsor benefits by having a convenient channel to advertise its name and obtain email addresses.

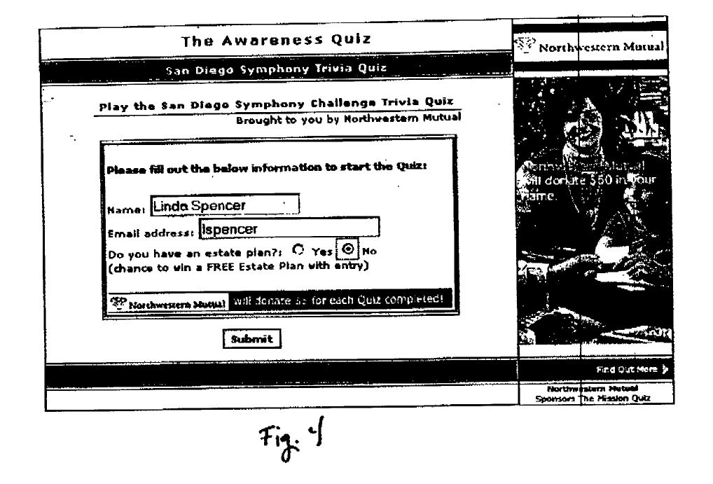

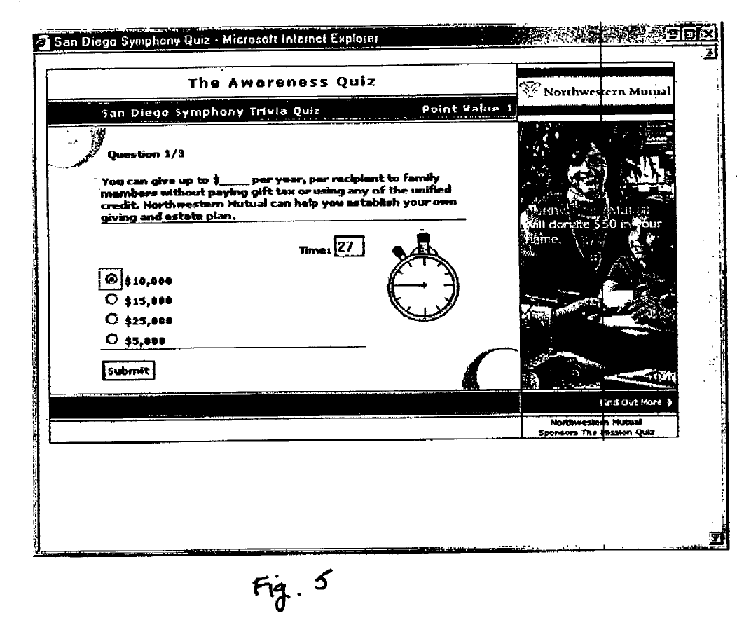

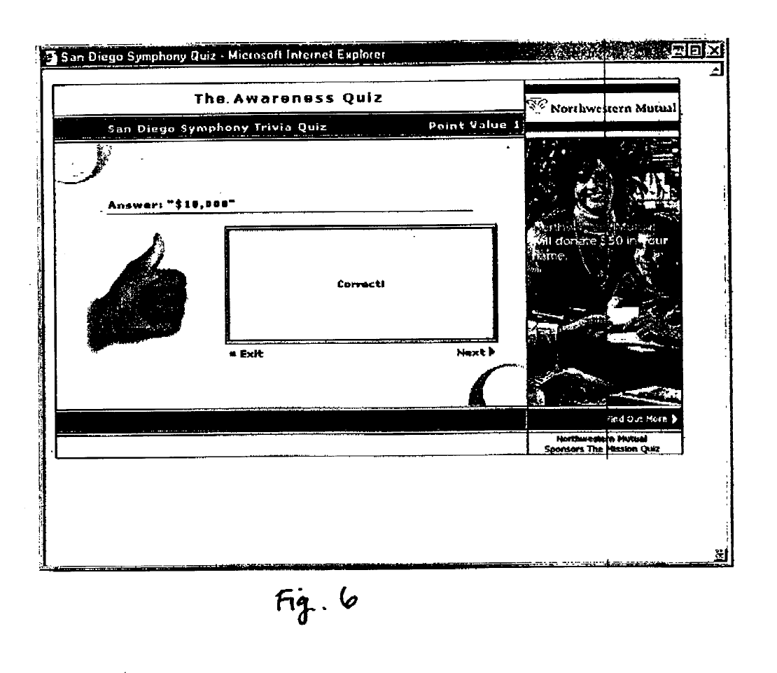

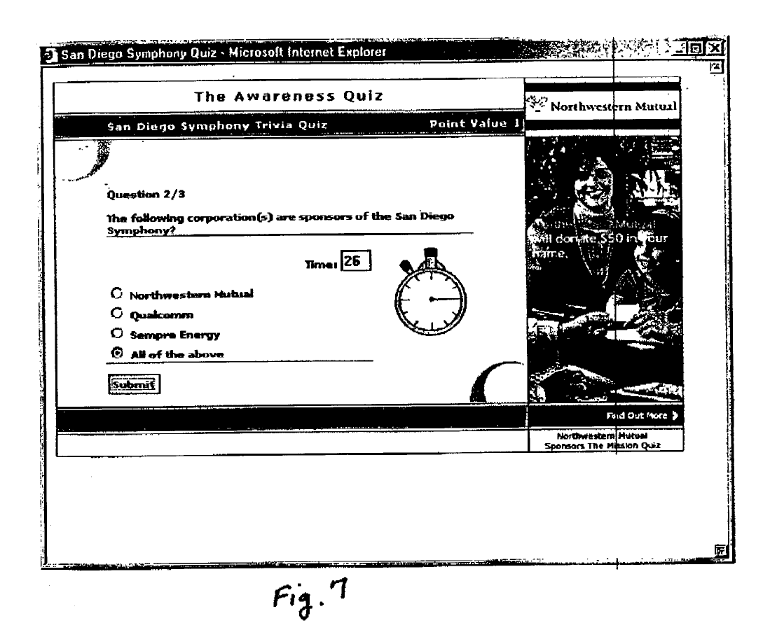

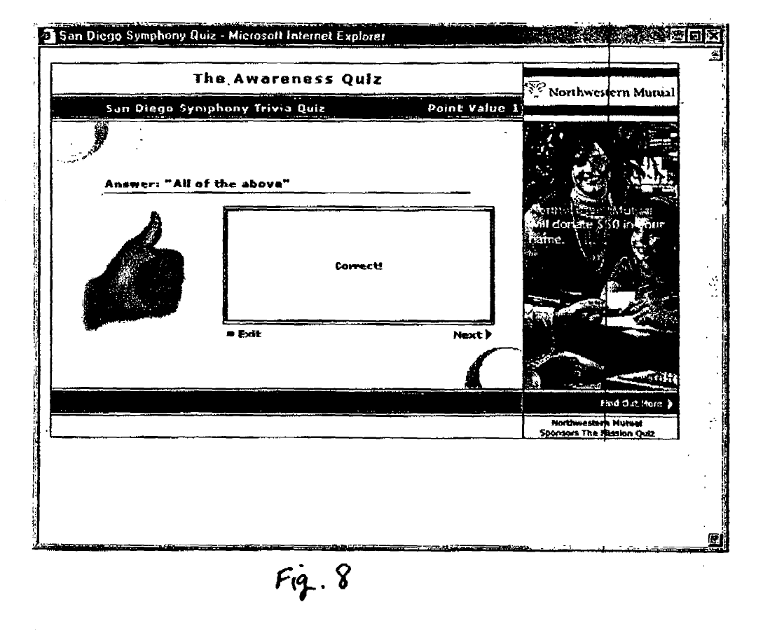

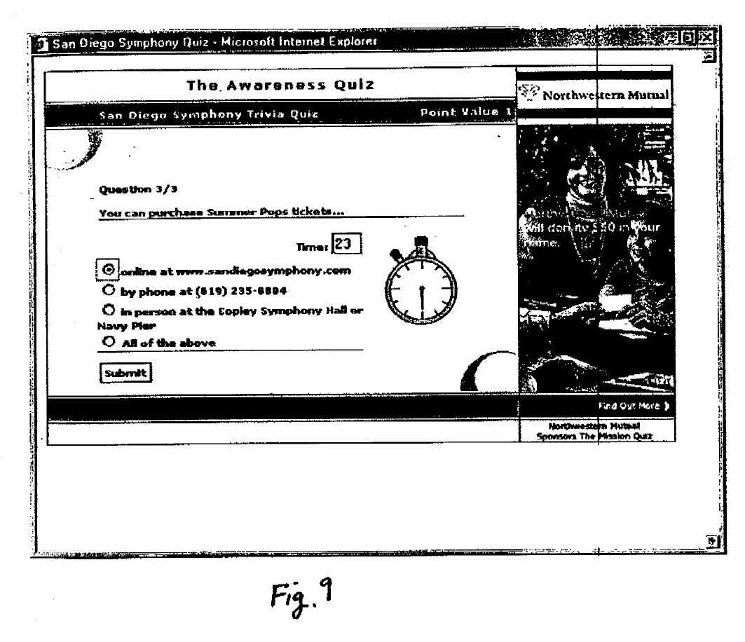

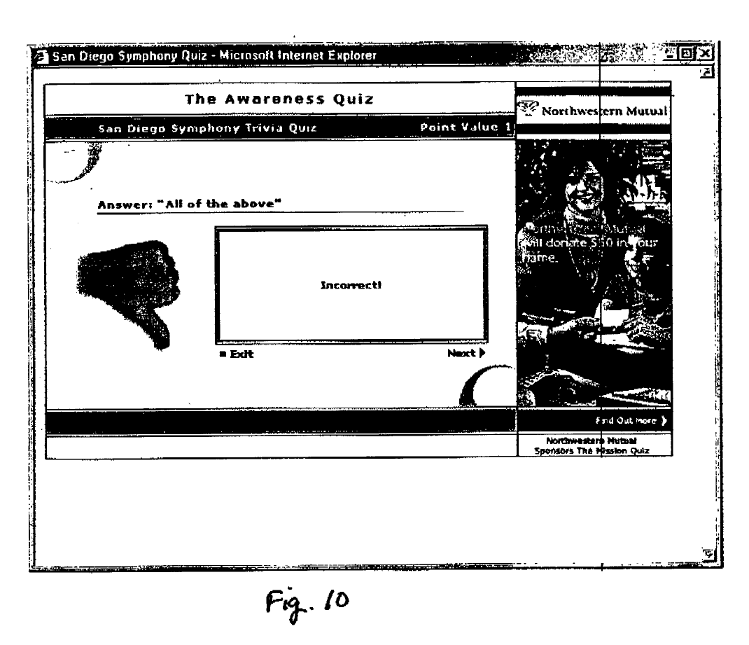

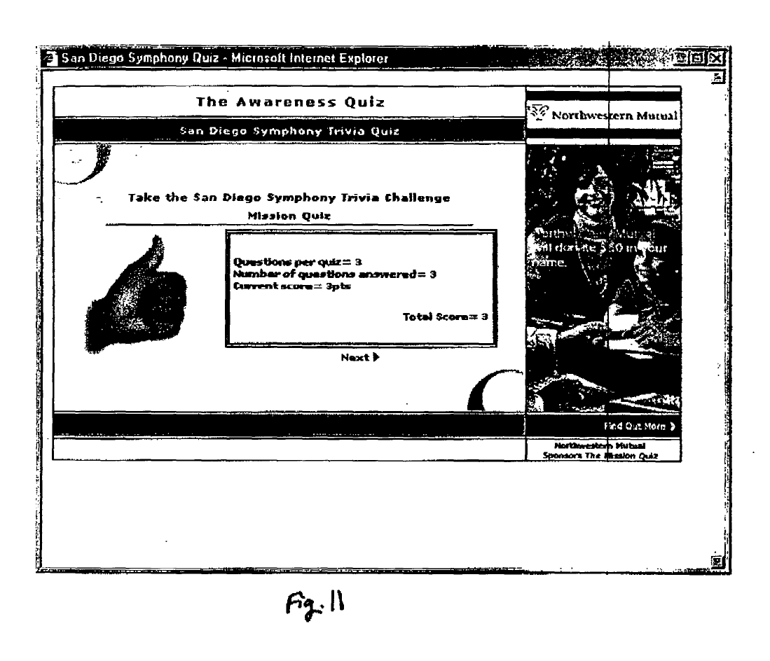

If a participant agrees to take the awareness quiz, the participant is asked to provide some information, such as name and email address, as shown in FIG. 4. FIGS. 5-11 shows how the awareness quiz is administered in accordance with one embodiment of the invention. The quiz typically includes one or more questions. The participants are presented with a question, and one or more answers are provided. The participant selects an answer from the provided answers, and the participant is then told whether the selected answer is correct or not. In one embodiment, if the participant selects an incorrect answer, then the system provides the correct answer.

The questions are designed to test the participant's knowledge about the NPO's missions and sometimes about the corporate sponsor's activities. By taking the quiz, the participants become more aware of both the NPO and the corporate sponsors.

In one embodiment, the participants are awarded a point for each correct answer and a total score is awarded at the conclusion of the quiz. Likewise, participants are awarded a score based on the performance in a game or in a trivia. This provides a measure of the participant's knowledge about the NPO and the corporate sponsor.

The system also keeps track of the total number of participants that have taken the quiz and the average score of all the participants. The system can also keep track of the number of times a question is answered correctly and incorrectly. The total number of participants, the average score of all participants, or the total score of all participants is a reasonable indicator of the level of public awareness of the NPOs and the corporate sponsors.

In one embodiment, the system displays the total score awarded to the participants. If more than one participant takes part as a team (in the quiz or in the game), then the total team score is also displayed.

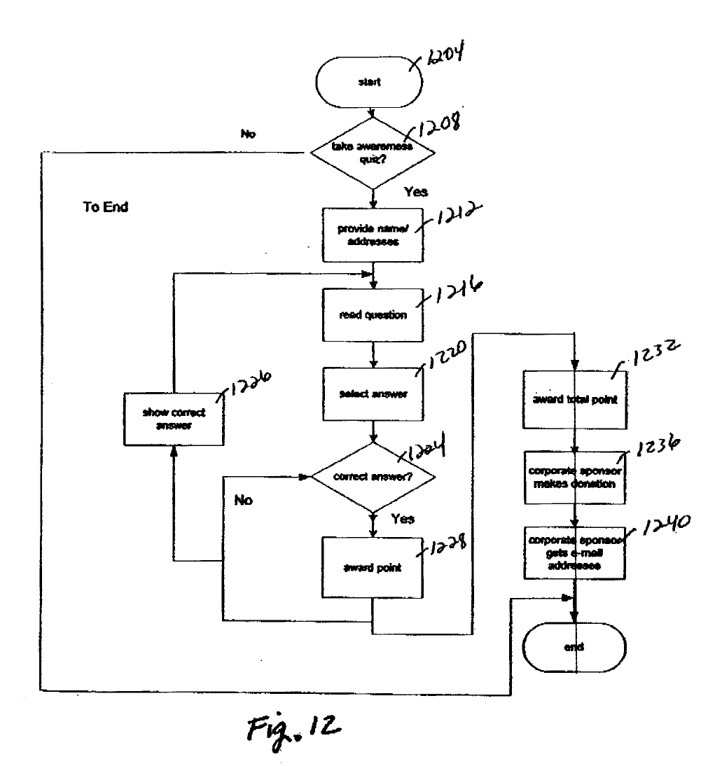

FIG. 12 is a flow diagram of the sequence of the method steps in accordance with one embodiment of the invention. The flow begins in step 1204 and moves to step 1208 where a participant decides whether to take a quiz. If the participant decides to take a quiz, in step 1212, the participant provides some information, such as name and address. Next, in step 1216, the participant reads a question. In step 1220, the participant selects an answer. Note that in one embodiment, the system provides two or more answers.

In step 1224, if the selected answer is correct, then the participant is awarded a point and the flow returns to step 1216. If the selected answer is incorrect, in step 1226, the correct answer is shown and the flow returns to step 1216. When all the questions are answered, in step 1232 a total score is awarded. Next, in step 1236, the corporate sponsor makes a donation to the NPO in the name of the participant. In step 1240, the corporate sponsor gets email addresses of the participants. The flow ends in step 1244. In one embodiment, step 1236 is optional, i.e., the corporate sponsor can make a donation if it so desires.

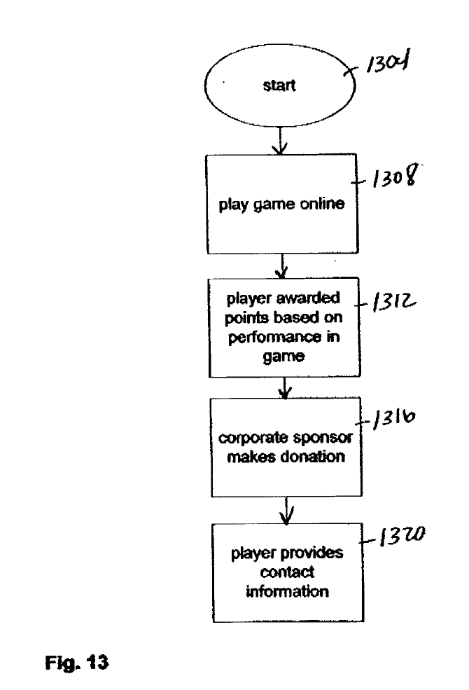

FIG. 13 is a flow diagram of the method steps in accordance with another embodiment of the invention. The flow begins in step 1304, and moves to step 1308 where a participant (also referred to as a player) plays a game online. In step 1312, the player is awarded points based on the performance in the game. In step 1316, a corporate sponsor makes a donation to a charitable, nonprofit other organization. In step 1320, the player provides contact information to the sponsor and the organization. In one embodiment, the player can win prizes based on the performance in the game, or the player can enter a sweepstakes in which prizes are awarded.

In one embodiment, the program code for carrying out the steps in accordance with the present invention can be stored in a storage medium and made available for sale as a software program or a computer program product. For example, the program code can be stored in a compact disk (CD), a magnetic tape, or any other type of storage medium. A manufacturer can make the software program available for sale so that individuals and business entities may purchase or otherwise obtain the software program to set up an automated, on-line donation processing system.

Although the preferred embodiments have been described, it should be understood that various changes, substitutions, and alterations can be made herein without departing from the scope of the present invention. It should be noted that the present invention can be implemented using virtually any computer system or other networking system and virtually any available programming language. Thus the implementation of the present invention is not limited to the computer network illustrated in this document. Other examples of changes, substitutions, and alterations are readily ascertainable by one skilled in the art and could be made without departing from the spirit and scope of the present invention as defined by the following claims.

What is claimed is:

1. A web-based, interactive method for simultaneously: (a) advertising and increasing awareness of charitable, nonprofit, philanthropic or other fundraising organizations (ORG), (b) advertising corporate or other sponsors (Sponsors), and (c) raising donations for the ORGs, the method having a graphical user interface including a display, comprising:
providing the participant an opportunity to take a quiz on a website in exchange for a Sponsor making a donation to an ORG in the participant's name, the quiz having one or more questions;
taking the quiz by answering the questions, the participant selecting an answer from two or more provided answers; and
making a donation, by the Sponsor, to the ORG.

2. The method according to claim 1, further comprising asking questions about the ORG's mission and activity.

3. The method according to claim 1, further comprising asking questions about the Sponsor's business or activities.

4. The method according to claim 1, further comprising receiving the contact information of the participant.

5. The method according to claim 2, wherein the contact information comprises the email address of the participant.

6. The method according to claim 1, further comprising providing a score based on the number of correct answers in the quiz.

7. The method according to claim 1, further comprising calculating the total number of participants taking the quiz.

8. The method according to claim 2, further comprising providing the contact information to the Sponsor.

9. The method according to claim 2, further comprising providing the contact information to the ORG.

10. The method according to claim 1, wherein the donation is made to the ORG selected by the participant.

11. The method according to claim 1, further comprising providing a sweepstake wherein the participant of the quiz has a chance to win a prize.

12. A web-based, interactive system for simultaneously: (a) advertising and increasing awareness of charitable, nonprofit, philanthropic or other fundraising organizations (ORG), (b) advertising corporate or other sponsors (Sponsors), and (c) raising donations for the ORGs, the system having a graphical user interface including a display, comprising:
means for providing the participant an opportunity to take a quiz on a website in exchange for a Sponsor making a donation to an ORG in the participant's name, the quiz having one or more questions;
means for taking, by the participant, the quiz, the participant answering the questions by selecting an answer from two or more provided answers;
means for making a donation, by the Sponsor in the participant's name, to the ORG.

13. The system according to claim 12, wherein the quiz includes questions about the ORG's mission and activity.

14. The system according to claim 12, wherein the quiz includes questions about the Sponsor's business or activities.

15. The system according to claim 12, further means for receiving the contact information of the participant.

16. The system according to claim 15, wherein the contact information comprises the email address of the participant.

17. The system according to claim 12, further comprising a score based on the number of correct answers in the quiz.

18. The system according to claim 12, further comprising means for calculating the total number of participants taking the quiz.

19. The system according to claim 12, further comprising means for providing the contact information to the Sponsor.

20. The system according to claim 12, further comprising means for providing the contact information to the ORG.

21. A web-based, interactive method for simultaneously: (a) advertising and increasing awareness of charitable, nonprofit, philanthropic or other fundraising organizations (ORG), (b) advertising corporate or other sponsors (Sponsors), and (c) raising donations for the ORGs, the method having a graphical user interface including a display, comprising:
playing a game on a website; and
making a donation, by the Sponsor, to an ORG.

22. The method according to claim 22, further comprising awarding one or more points to the player based on the performance in the game.

23. The method according to claim 22, wherein the player enters a sweepstake by playing the game, and wherein the player has an opportunity to win on or more prizes.

24. The method according to claim 21, further comprising receiving the contact information of the player.

25. The method according to claim 22, wherein the contact information comprises the email address of the player.

26. The method according to claim 21, further comprising calculating the total number of players.

27. A computer program product including a program code embodied in a storage medium for carrying out a web-based, interactive method for simultaneously: (a) advertising and increasing awareness of charitable, nonprofit, philanthropic or other fundraising organizations (ORG), (b) advertising corporate or other sponsors (Sponsors), and (c) raising donations for the ORGs, the method having a graphical user interface including a display, comprising:
playing a game on a website in exchange for a Sponsor making a donation to an ORG;
making a donation, by the Sponsor, to the ORG; and
providing contact information of the player.
